(19) United States
(12) Patent Application Publication
(10) Pub. No.: US 2004/0047803 A1
(43) Pub. Date: Mar. 11, 2004

(54) Synthesis and stabilisation of nanoscale zeolite particles

(76) Inventors: Valentin Panov Valtchev, Illfurth (FR); Thomas Bein, Grafelfing (DE)

Correspondence Address: Ronald R Santucci, Frommer Lawrence & Haug, 745 Fifth Avenue, New York, NY, 10151, US

(21) Appl. No.: 10/416,613

(22) PCT Filed: Nov. 14, 2001
(86) PCT No.: PCT/EP01/13190

(30) Foreign Application Priority Data
Nov. 14, 2000 (DE) 100 56 362.7

(51) Int. Cl. C01B 39/02

(52) U.S. Cl. 423/716; 423/702; 423/705

(57) ABSTRACT

The present invention relates to a method for the preparation of zeolite particles having an average particle size of less than 1000 nm, wherein a) a solution of a silicate and/or germanate source and a base is prepared, b) a solution of an aluminate and/or gallate source and a base is prepared, and c) the solutions a) and b) are brought together, mixed and reacted, characterised in that the pH value of the solution in step a) is at least 11 and the pH value of the solution is step b) is at least 11. The invention furthermore relates to nanoscale zeolite particles obtainable by a method according to the invention and to colloidal suspensions comprising the nanoscale zeolite particles.

The present invention relates to zeolites whose average dimensions are in the nanometre range and to methods for the preparation thereof. These zeolites may, especially after they have been purified, form stable colloidal suspensions having very low sedimentation rates. The invention relates especially to methods wherein nanoscale zeolites are prepared under specific conditions from alkaline aluminium silicate gels that do not contain organic bases.

Aluminium silicate zeolites are a well-known class of molecular sieves which are used in many chemical methods (D. Breck, “Zeolite Molecular Sieves”, John Wiley and Sons, New York, 1974). For example, zeolite A (the synthesis of which is described, for example, in DE 1 095 795 (Oct. 3, 1958)) has long been used as an ion-exchanger in apparatus for water-softening and in detergents. In the latter case, the zeolite is used to replace, partly or entirely, inorganic phosphate builders such as sodium tripolyphosphate (E. V. R. Borgstedt, H. S. Sherry, J. P. Slobogin, Studies in Surface Science and Catalysis, Vol. 105, 1659-1666, Elsevier 1997). For example, EP 0 002 960 A1 (Dec. 27, 1978) teaches that dispersed crystals of zeolite A having a uniform mean particle size of between 1 and 10 μm are prepared by adding a specific number of comminuted seed crystals having a mean particle size of less than about 0.5 μm to sodium aluminium silicate gels. The teaching of patent DE 30 02 278 A1 (Jan. 23, 1980) comprises a two-step method for the preparation of zeolite 4A (the sodium form of zeolite A) having particle sizes between about 2×10 μm, especially for use in washing agent detergents. Another interesting zeolite for washing applications is zeolite P (for example, a continuous preparation method is described in WO 96/14270, Nov. 07, 1994).

Zeolite Y is of great interest as a catalyst support, for example in catalytic fluid cracking. The teaching of U.S. Pat. No. 4,576,807 (Mar. 18, 1986) comprises preparation of zeolite Y by seeding sodium silicate at room temperature with a small amount of zeolite Y seed crystals, followed by addition of sodium aluminate and heating.

Zeolite crystals prepared under conventional synthesis conditions frequently have a mean particle size of between 1 and 5 μm. The particle sizes generally have a wide distribution.

For some purposes, the use of small zeolite particles is desirable, and the quality of zeolite crystals is frequently improved when the size of the crystals is reduced. In some applications it would also be useful if the zeolite particles were sufficiently small to form a colloidal suspension. In addition to applications in the chemical processing industry, the small zeolite particles can also be used as seed crystals in zeolite synthesis, in order to control the process conditions and product properties. Nanoscale zeolite particles of a substantially uniform, reproducible and controllable size are accordingly necessary for a number of industrial applications. For example, small zeolite particles are useful in formulations of washing agents, wherein water-softening by means of rapid ion-exchange of calcium and magnesium, greater building capacity, more rapid suspendibility, lower mechanical wear on equipment and reduced residues on fabrics are desirable properties. Furthermore, stable colloidal suspensions, which require particles of a sub-micron particle size, are needed in liquid washing agents. It is also assumed that a higher concentration of dissolved silicate in the presence of small crystallites can promote corrosion prevention (EP 0 315 282 A1, Nov. 04, 1987). Detergent formulations can frequently be produced more easily by means of slurries in spray towers (depending upon the distance from the zeolite producer); this favours the use of stable colloidal suspensions. When the particle size is too large for the formation of stable suspensions, complex stabilisation systems including non-ionic surface-active agents (such as oxoalcohol), sodium alkylbenzenesulphonate and polymers are required to prevent settling (EP-A-357 989), as a result of which costs are increased and the amount of freedom for formulating the detergent is limited.

In the context of catalytic reactions, a small crystal size results in reduced diffusion resistance (K. Beschmann, L. Riekert, J. Catal., 1993, 141, 548-565) and possibly in a reduction in the deactivation rate of the zeolite because of the deposition of abraded material on the outer surface of the crystals (M. Yamamura, K. Chaki, T. Wakatsuki, H. Okado, K. Fujimoto, Zeolites, 1994, 14, 643-649).

A number of methods for the preparation of small and sub-micron zeolite crystals are already described in the literature and in patents.

Sub-micron crystals of zeolite 4A and P1 having a size mainly between 100 and 1000 nm are claimed in EP 0 315 282 A1 (Nov. 04, 1987) for use in liquid detergents. In the case of P1, a hot solution of sodium aluminate (at 90° C.) is mixed with a hot solution of sodium metasilicate pentahydrate with vigorous stirring, is held at 90° C. for 5 hours and is then filtered. For the preparation of small zeolite A, reference is made to Example 2 in the German Patent DE 1 095 795 (Oct. 3, 1958), although this patent does not mention particle size. It is claimed that 80% of the zeolite A product by weight is smaller than 800 nm. Zeolite P of small particle size (about 50% by weight being smaller than 800 nm), obtained by wet-grinding, is claimed in WO 96/34828 (May 01, 1995). It is stated that grinding does not adversely affect the detergent properties of the zeolite.

Patent EP 1 002 764 A1 (Nov. 02, 1999) describes a method for the preparation of small zeotype crystals (zeolites and related materials) comprising the preparation of a precursor gel inside a porous material having pores of less than about 100 nm, for example carbon or MgO, or aluminosilicate. The synthesis of ZSM-5 in carbon and MgO and of LTA and SOD in aluminosilicate and SOD in MgAl₂O₄ is described.

The use of a cold silicate precursor solution (−9 to +10° C.) for the preparation of small crystals of zeolite Z-14 (a form of zeolite X) is described in FR 1,566,843 (Apr. 16, 1968). Zeolite particle sizes of between 20 and 100 nm are claimed.

Mono- or di-saccharides can be used to keep the crystal size of faujasite (zeolite X and Y) small, as described in U.S. Pat. No. 4,372,931 (Feb. 08, 1983). Sucrose, dextrose or other saccharides are added to a conventional aluminium silicate reaction mixture obtained by mixing aqueous alkali metal silicate and alkali metal aluminate solutions at low temperatures, followed by ageing and hydrothermal synthesis. Crystal sizes of between about 30 and 40 nm are claimed, although the products are not characterised with respect to their colloidal properties.

Many of the above-mentioned patents claim the preparation of small zeolite particles. The properties of the resulting suspensions are, however, not described in detail. This point is addressed in two relatively recent patents for specific synthetic systems.

WO 93/08125 (Oct. 23, 1991) claims molecular sieves which comprise crystals or agglomerates having an average diameter of 100 nm or less. It is said of these materials that they form stable colloidal suspensions of zeolites including MFI, MEL and BEA and that they are produced by preparing a boiling aqueous synthesis mixture of the silicate source and an organic structure-directing agent (in the form of a hydroxide) in an amount (excess) that is sufficient to bring about dissolution of the silicon dioxide. The crystal size was controlled by selection of the crystallisation temperature (smaller size at lower temperature).

In WO 94/05597 (Sep. 02, 1992), colloidal suspensions of discrete particles of a zeolite are produced from clear aluminosilicate solutions stabilised with tetraalkylammonium. The major part of the alkali is made available in the form of tetraalkylammonium hydroxide (TMAOH). The aluminium is made available in the form of tetraalkylammonium aluminate and is added to an alkali-stabilised silica gel or silicate, with vigorous mixing, followed by hydrothermal synthesis at up to 100° C. and centrifugation. Various zeolites such as zeolite A, faujasite, ZSM-2 and hydroxysodalite are obtained by adding additional metal hydroxide solution. Suspensions having a very narrow particle size distribution with an average size of less than 250 nm and low sedimentation rates are described. Ion-exchange of the zeolites in the sol with an ion-exchanger resin and also suspensions of the particles in ethanol are likewise described.

It should be noted that in both WO 93/08125 and WO 94/05597 extensive use is made of expensive alkylammonium salts, which are employed either as structure-directing agents and/or as stabilisers for the framework precursor species.

As mentioned hereinbefore, the size of the zeolite crystals can be influenced by controlling the starting composition and the crystallisation conditions. Many zeolite materials can be produced in the form of small crystals where the size of the individual crystals is in the nanometre range. In typical zeolite syntheses, however, the crystals form aggregates of larger size and wide particle size distribution. The suspensions prepared from such products do not have the properties of typical colloidal suspensions but tend to separate out. The preparation of zeolite particles of nanoscale size and narrow particle size distribution, which are capable of forming colloidal suspensions, usually requires special conditions. As described hereinbefore, for example, large amounts of organic structure-directing agents, a low alkali content, special silicate and aluminate sources and clear homogeneous starting solutions have been used (WO 94/05597, WO 93/08125).

One problem of the invention is to make available a method for the preparation of nanoscale (<1000 nm) zeolites which, especially after purification, form stable colloidal suspensions.

A further problem of the invention is to make available a method for the preparation of nanoscale zeolites without the use of (often expensive and toxic) organic structure-directing agents during synthesis.

A further problem of the invention is to prepare nanoscale zeolites which, especially after post-synthesis treatment, form stable colloidal suspensions.

A further problem of the invention is to make available a method for the preparation of small zeolite particles in the form of colloidal suspensions.

A further problem of the invention is to make available a method for the preparation of redispersible small zeolite crystals.

Those problems are solved by a method for the preparation of nanoscale zeolite particles wherein

a) a solution, especially an aqueous solution, of a silicate and/or germanate source and a base is prepared,

b) a solution, especially an aqueous solution, of an aluminate and/or gallate source and a base is prepared, and

c) the solutions a) and b) are brought together, optionally mixed, and reacted; characterised in that

the pH value of the solution in step a) is at least 11, preferably at least 12, more preferably at least 13, and most preferably at least 14; and

the pH value of the solution in step b) is at least 11, preferably at least 12, more preferably at least 13, and most preferably at least 14.

Furthermore, there are made available nanoscale zeolite particles which can be prepared by the method according to the invention and especially colloidal suspensions of the nanoscale zeolite particles.

The present invention accordingly makes available a method for the preparation of nanoscale zeolite crystals which, especially after purification and stabilisation, have typical colloidal dispersion or suspension properties and, especially, a very low sedimentation rate. The method of synthesis differs from the methods described in the patent literature (WO 94/05597, WO 93/08125) especially in that large amounts of expensive alkylammonium bases are used therein and in that, in accordance with the invention, the use of organic structure-directing agents is preferably avoided. Using the method according to the invention it is also possible to avoid using seed crystals.

Preference is given herein to the molar ratio of base to silicate and/or germanate source in step a) being at least 2:1, preferably at least 7:1, more preferably at least 10-20:1 and especially 25-30:1, and to the molar ratio of base to aluminate and/or gallate source in step b) being at least 2:1, preferably at least 7:1, the molar ratio referring to the concentrations of OH- and Si-, Ge-, Al- and Ga-containing ions.

As bases there are preferably used alkali and/or alkaline earth bases, with preference being given to use of the same bases in steps a) and b).

The silicate and/or germanate particles present in the solution in step a) should preferably have a mean particle size of max. 10 nm, and

the aluminate and/or gallate particles present in the solution in step b) should preferably have a mean particle size of max. 10 nm.

The solutions a) and b) are preferably in the form of clear solutions. A solution is clear especially when it comprises dissolved silicate and/or germanate particles (solution a)) or aluminate and/or gallate particles (solution b)) of a mean particle size of max. 10 nm. In particular, a clear solution usually comprises—based on the dry weight—less than 5% by weight, preferably less than 1% by weight, especially less than 0.1% by weight, aggregates and particles of a mean particle size of more than 10 nm. A clear solution of that kind can be achieved, for example, by means of a high content of base (a high pH value) and, where appropriate, by means of vigorous stirring for homogenisation of solutions a) and b) and also, where appropriate, c). It is, furthermore, advantageous, for formation of a clear solution, to wait for a sufficiently long period, that is to say, for example, at least 1-5 hours, with vigorous stirring preferably being carried out throughout.

Where appropriate, solutions a) and/or b) can also be pre-heated up to 90° C.; however, pre-heating is usually not necessary and indeed in some cases is even undesirable. Likewise, solutions a) and/or b) may also be cooled because elevated temperatures may occur in the course of the reaction in step c). In some cases, ultrasound may also be used in order to promote the formation of clear solutions.

The present invention especially identifies the conditions for controllable synthesis of nanoscale zeolite particles for zeolites which are extensively used in industry, such as LTA-, FAU-, MFI- and EDI-type zeolites.

A particular feature of nanoscale particles is their large external surface area. In contrast to conventional zeolites, where the surface area is typically in the range from a few m²/g up to 20 m²/g, the nanoscale zeolites described herein have external surface areas of more than 50 m²/g, preferably more than 100 m²/g.

In some cases, the particle size of the zeolites may still be too large for certain desired uses and/or the agglomeration behaviour of the zeolite crystals formed must be further improved. In those situations, the invention makes available a method for the purification and/or stabilisation of nanoscale zeolite particles. The purification may be carried out, for example, by removing some of the alkali and/or alkaline earth ions. There may accordingly be removed, for example, up to 30% by weight, preferably up to 70% by weight and especially more than 90% by weight, of the ions. In the process, the small ions such as, for example, Na+ or K+ may be replaced by larger ions such as NH₄⁺. The stabilisation may also be carried out by adding small amounts (typically from 0.05 to 3% by weight of dispersant, based on the total amount of the zeolite) of surface-active coupling agents and/or suitable surface-active agents or polymers either to the synthesis solution c) or to the purified suspension d). The agents used both for controlling the particle size and also the agglomeration behaviour in the synthesis solution include silane coupling agents such as aminopropylmethoxysilane, glycidyloxypropyltrimethoxysilane, trimethylmethoxysilane, organic esters of phosphonic or phosphoric acids such as dimethyl methyl phosphonate or dibutyl phosphate. Those agents may be added at any suitable time during the course of the reaction.

Especially after purification of the nanoscale zeolites, dispersants may be added in order to stabilise the colloidal suspensions additionally or alternatively against agglomeration. Those dispersants act either by means of steric interactions, wherein certain groups such as alkyl or oligoethylene oxide chains extend into the solvent, or by repulsive electrostatic forces, or by a combination thereof. Such agents include monomeric surface-active agents such as metal oleates, sodium alkylbenzenesulphonate, hexadecyltrimethylammonium bromide or sodium N-methyl-N-oleyl laurate. Polymers are frequently especially effective and include homopolymers such as poly(ethyleneimine), poly(ammonium acrylate), poly(amino acids) or poly(ethylene glycol) and copolymers such as acrylic acid-methacrylic acid copolymer or formaldehyde-sodium alkylnaphthalenesulphonate. From the afore-mentioned examples it will be seen that the dispersants include non-ionic, cationic and anionic surface-active agents in monomeric or polymeric form. In addition to the afore-mentioned dispersants, a large number of suitable dispersants are available today and the skilled person will be able to select suitable agents for specific purposes such as stabilisation in water, in organic solvents such as ethanol or at certain particle concentrations. Typical amounts are in the range from 0.05 to 3%, by weight, of dispersant relative to the total amount of the zeolite in the suspension. Representative examples are discussed in Z. Amjad, Dispersion of iron oxide particles in industrial waters. The influence of polymer structure, ionic charge and molecular weight. Tenside, Surfactants, Deterg. 36, 1999, 50-56; S. Wache, J. Plank, I. Moertlbauer, Wasser-Iösliche Polymere als Dispergiermittel für keramische Suspensionen, DE 198 30 771, Jul. 09, 1998; K. Yoshitake, T. Yokoyama, Process for producing hydrophobic organosilica sol, EP 881 192, May 26, 1997; J. Clayton, Pigmentidispersant interactions in waterbased coatings, Pigm. Resin Technol. 27, 1998, 231-239; A. Dromard, C. Richard, Stable aqueous suspensions of precipitated silica (onium salt dispersants), EP 368 722, Nov. 8, 1988; J. Schmitz, H. Frommelius, U. Pegelow, H.-G. Schulte, R. Hofer, A new concept for dispersing agents in aqueous coatings, Prog. Org. Coat. 35, 1999, 191-196); P. Calvert, R. Lalanandham, M. Parish, E. Tormey, Dispersants in ceramic processing, Br. Ceram. Proc. 37, 1986, 249-53; and N. Tsubokawa, Modification of particle surfaces by grafting of functional polymers, Spec. Publ. -R. Soc. Chem. 235, 1999, 36-51.

The present invention accordingly makes available a method for the preparation of zeolite crystals or aggregates of such crystals of nanoscale size having a relatively narrow particle size distribution of, for example ±30%, preferably ±20%, starting from solutions comprising monomers and/or silicate or germanate particles of low mass and aluminate or gallate particles, preferably proceeding as follows:

use of silicate and/or germanate sources and aluminate and/or gallate sources which have, after dissolution, a particle diameter of preferably ≦10 nm, more preferably ≦5 nm and especially ≦3 nm;

addition of alkali and/or alkaline earth bases in an amount that is sufficient for complete dissolution of the silicate and/or germanate and aluminate or gallate sources, the alkali and/or alkaline earth base and silicate and/or germanate source being in a molar ratio of at least 2:1, preferably at least 7:1;

vigorous mixing of the precursor solutions a) and b) in order to produce a synthesis mixture having as homogeneous a distribution of the components in the starting system as possible; after mixing, the particles have a mean particle size of preferably ≦2 mm, especially ≦0.5 mm; in most cases, before mixing, a gel is present, which is broken up by the mixing into dispersed particles such as, for example, flakes, having a mean particle size of preferably ≦2 mm, especially ≦0.5 mm;

crystallisation of the synthesis mixture at a moderate temperature for each specific zeolite, resulting in the desired mean particle size; such temperatures are preferably from 10 to 60° C., especially from 20 to 60° C. or from 30 to 60° C.;

optionally, treatment with a surface-active agent or stabilising agent.

The colloidal suspensions preferably have a content of zeolite particles of at least 1% by weight, based on the weight of the solvent. As suspending agents there are preferably used water and/or organic solvents such as ethanol. Such suspensions may comprise one or more zeolites and, optionally, further additives that are customary per se in such suspensions and necessary for the desired function, for example dispersants.

In accordance with the invention, silicate, germanate, aluminate and gallate sources refer to compounds from which silicates, aluminates and gallates can be liberated under basic conditions.

The mean particle sizes (= mean particle diameters) mentioned in this Application can be determined, in a manner known per se, by means of dynamic light scattering. Alkali silicates and alkaline earth silicates such as sodium silicates and silica sols, Aerosils and organic silicon complexes such as silicon alkoxides are preferred silicate sources, further preferred silicate sources being any silicate source which, after dissolution, has a mean particle diameter of preferably ≦10 nm, more preferably ≦5 nm and especially ≦3 nm. Corresponding germanates etc. are preferred germanate sources. The aluminate and/or gallate sources and/or the silicate and/or germanate sources and especially the silica sol can, each independently of the other(s), have, after dissolution, a mean particle size of, for example, up to 10 nm, preferably up to 5 nm and especially up to 3 nm.

Amorphous aluminium hydroxides having a small mean particle size, alkali aluminates or aluminium alkoxides are preferred aluminate sources. Corresponding gallates etc. are preferred gallate sources.

The alkali cations are introduced into the synthesis mixture preferably in the form of a hydroxide. Preferred alkali metals are sodium and potassium, but the use of Li, Rb, Cs, NH₄ and also the use of alkaline earth metals such as Ca, Ba, Sr etc. are also possible.

The alkali or alkaline earth bases should preferably be present in the precursor solutions in amounts which make possible the formation of monomers and silicate and/or germanate species of low mass (mean particle size after dissolution preferably ≦10 nm, more preferably ≦5 nm and especially ≦3 nm). For that purpose, a molar ratio of (for example, alkali and/or alkaline earth) bases to the silicate and/or germanate of 2:1 or more will typically be necessary. Preferred ratios are: ≧7:1. The total amount of alkali in the zeolite precursor system should preferably be sufficient to make possible the formation of a separate aluminate and/or gallate solution in which Al(OH)⁻₄ and/or Ga(OH)⁻₄ is the dominant anionic species.

Zeolite crystallisation is greatly dependent upon the nature and/or state of the silicate and/or germanate species in the precursor. Usually, many different anionic silicate and/or germanate species are present in the alkaline precursor solutions a) used in the zeolite synthesis. The nature of the polysilicate and/or polygermanate anions in an alkaline solution depends on the pH value of the system (e.g. pH 11-14), the nature of the alkali metal and/or alkaline earth metal (e.g. Na⁺, K⁺), the presence of aluminium or of some salts in the system (e.g. Na₂SO₄), the temperature (e.g. room temperature up to 250° C.), the origin of the silicate source, and other factors. It is difficult to achieve precise control of the silicate and/or germanate anions in the zeolite precursor solutions. In particular, at a high pH value monomers and silicate species of low mass predominate.

In contrast to the alkaline silicate and/or germanate solutions, the chemistry of the alkaline aluminate and/or gallate solutions is relatively simple, with Al(OH)⁻₄ and/or Ga(OH)⁻₄ being the main anionic species (R. M. Barrer “Hydrothermal Chemistry of Zeolites”, Academic Press, London, 1982).

Vigorous mixing of the alkali silicate and/or germanate and aluminium and/or gallate solution prepared as described hereinbefore results in a zeolite precursor mixture in which all the components are homogeneously distributed in gel particles.

The silicate and/or germanate sources and the aluminate and/or gallate sources preferably are readily soluble in the base. Such sources are readily soluble, for example, if they form a clear solution when stirred for, at the most, 30 minutes. Such solutions comprise, for example, particles having the mean particle sizes mentioned hereinbefore.

It has accordingly been found that nanoscale zeolite particle having a narrow particle size distribution can be obtained by crystallising alkali and/or alkaline earth alumino-silicate or -germanate precursor gels produced by vigorously mixing silicate or germanate and aluminate or gallate solutions comprising silicate or germanate species of low mass and aluminate or gallate species. In accordance with the invention, the zeolite particles may have a mean particle size of ≦500 nm, preferably ≦300 nm, more preferably ≦200 nm, especially ≦100 nm.

The method may be used to prepare any zeolite or any zeolite-like material which can be crystallised from alkali alumino-silicates or -germanates or related gels. The zeolite material may be composed mainly of aluminosilicate, or aluminium and/or silicon may be replaced to a varying extent by gallium, germanium, phosphorus, boron, titanium, iron, chromium, beryllium, vanadium and other elements. The synthesis mixture may accordingly comprise other starting materials that have been adjusted as is necessary for the synthesis of the desired molecular sieves.

The size of the zeolite particles may be adjusted by varying the composition of the synthesis mixture (e.g. the Si/Al ratio) and also the preparation parameters (e.g. the temperature, the intensity and duration of stirring). The content of SiO₂, GeO₂, Al₂O₃, Ga₂O₃, H₂O and also the OH/SiO₂ or OH/GeO₂ ratio have a marked effect on the final mean zeolite particle size. In accordance with the present invention, the alkali and/or alkaline earth content in the starting solutions should be adjusted (e.g. 2:1, 7:1, 10:1, especially ≧12:1 such as about 15:1) in order to control the solubility of the silicate and/or germanate and aluminate and/or gallate sources. The other components may, however, be varied to a great extent in order to control the nature and size of the zeolite particles. For example, the mean particle size can be varied by modifying the amount of aluminium or gallium and water in the system. An increase in the aluminium or gallium content usually results in a reduction in crystal size. Reducing the water content of the system can have a similar effect.

The crystals or aggregates according to the invention have external surface areas of preferably ≧50 m²/g, especially ≧100 m²/g and more especially ≧200 m²/g.

Vigorous mixing (for example, as mentioned hereinbefore) of the starting system is likewise an important factor in the preparation of the nanoscale zeolite particles. When alkaline aluminate and/or gallate and silicate and/or germanate solutions are mixed, a gel is usually rapidly formed. Mixing of the two precursor solutions is very important for obtaining a homogeneous starting system which is capable of yielding nano-crystals of a consistent size. There should preferably be used vigorous stirring means (e.g. having a stirring speed of ≧500 revs./min.) in order to avoid inhomogeneities in the system. The rate of introduction of the aluminate and/or gallate and silicate and/or germanate solutions into the stirring unit is likewise of importance (e.g. faster than 0.01 litre/s, preferably faster than 0.1 litre/s or faster than 1 litre/s).

The crystallisation temperature has a pronounced effect on the final crystal size. It may generally be stated that lower temperatures result in smaller mean particle sizes (for example, at a temperature of up to 60° C., a zeolite having a particle diameter of 100-400 nm is obtained). A differentiating feature of the system described in the present invention is the high reactivity, which makes possible crystallisation at surprisingly low temperatures over relatively short crystallisation times.

The final size of a specific zeolite can accordingly be controlled very precisely by selecting a suitable combination of factors controlling the mean zeolite particle size.

Examples of molecular sieves which can be prepared in accordance with the method of the present invention in the form of stable colloidal suspensions include, but are not limited to, LTA-, FAU- and EDI-type zeolites.

In accordance with the invention there are furthermore made available suspensions of nanoscale zeolite particles. For that purpose, the zeolites according to the invention are suspended in a suitable medium such as, for example, water, for example with vigorous stirring. The suspensions comprise more than 80% by weight, preferably more than 90% by weight, more preferably more than 95% by weight and especially more than 99% by weight, of zeolites having a particle size of less than 1000 nm, preferably less than 500 nm, more preferably less than 100 nm, even more preferably less than 50 nm. After a period of resting for 1 hour, the suspensions usually have no sediment.

### EXAMPLES

### Example 1

This method illustrates the preparation of nanoscale LTA crystals having a mean particle size of 210 nm and a narrow particle size distribution.

The reactants used in this experiment are indicated below. The mass of each reactant is given in grams and the product number of each reactant is indicated in brackets, after the name of the manufacturer/supplier.

| | | |
|---|---|---|
| Sodium hydroxide pellets (97%) | 47.7 | (Aldrich, 22, 146-5) |
| Sodium aluminate | 10.58 | (Riedel-de Haen, 13404) |
| (53% Al₂O₃, 44.5% Na₂O) | | |
| Sodium silicate solution | 22.22 | (Riedel-de Haen, 13729) |
| (27% SiO₂, 10% NaOH) | | |
| Distilled water | 200.0 | |

Two solutions, one of sodium aluminate (A) and one of sodium silicate (B) were prepared by mixing aluminate and silicate sources, separately, with water and adding a suitable amount of sodium hydroxide. The mass of the reactants in grams for each solution was:

(A) 10.58 NaAlO₂+74 H₂O+19 NaOH

(B) 22.22 Na₂Si₃O₇+126 H₂O+28.7 NaOH

The two solutions were stirred in closed vessels until all the components were completely dissolved. Dissolution of the components was indicated by the clarity of the solution. Solution (A) was then added to solution (B) with vigorous stirring (V=700 revs./min.) and homogenised for 45 minutes, the solutions remaining warm (40-50° C.) for that length of time owing to the exothermal reaction of the solution of sodium hydroxide. The resulting mixture is milky-white and of low viscosity.

The molar composition of the synthesis mixture was:

7Na₂O: 0.55Al₂O₃: 1.0SiO₂: 120H₂O

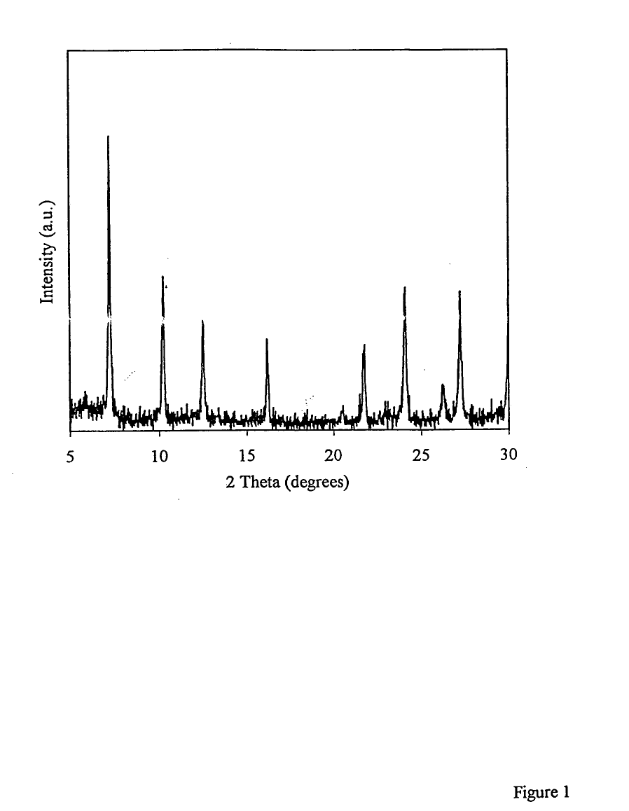

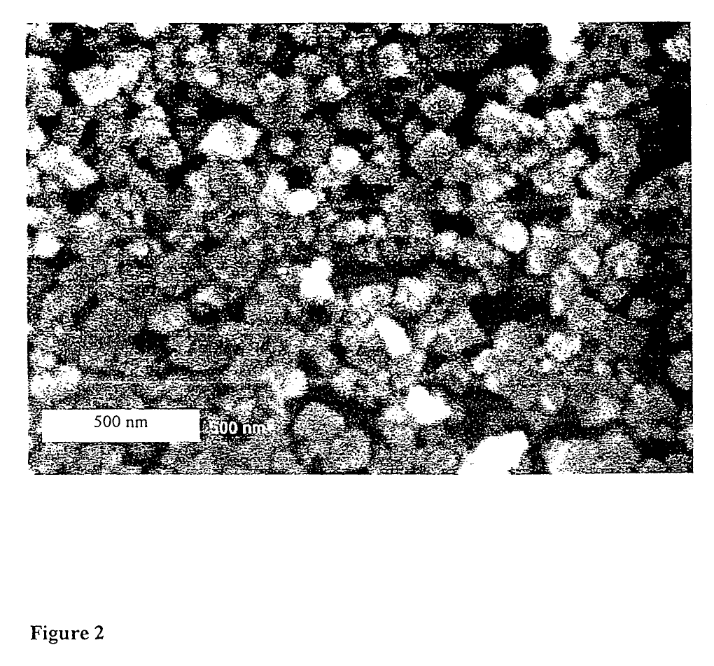

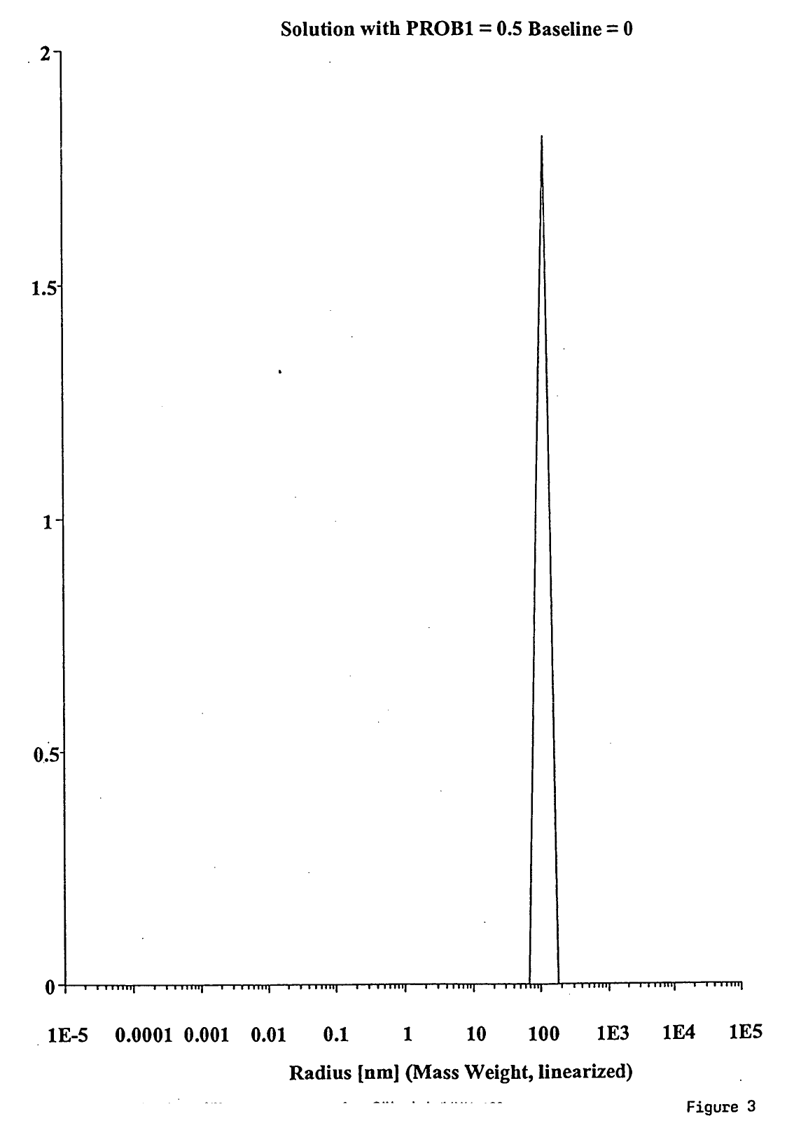

The synthesis was carried out in a polypropylene bottle for 20 hours at 37° C. The solid product was separated off from the mother liquor by centrifugation (V=15,000 revs./min. for 30 minutes), was redispersed in distilled water using an ultrasonic bath and was then centrifuged under the same conditions. The washing was repeated until the pH value of the washing water was less than 9. After the final washing step, the LTA crystals were again redispersed in distilled water and the pH value was adjusted to a value between 9 and 10 by adding dilute NH₄OH. The crystals exhibit no tendency to sedimentation. An X-ray diffraction diagram pattern, an electron micrograph and the particle size distribution of the product are shown in FIGS. 1, 2 and 3, respectively. The external surface area of the product was determined by the BET method to be 125 m².

### Example 2

This Example illustrates the influence of the synthesis temperature on the size of the colloidal LTA crystals.

The reactants used in this experiment, their manufacturer's/supplier's number and the mass of each reactant in grams are indicated below:

| | | |
|---|---|---|
| Sodium hydroxide pellets (97%) | 180.0 | (Aldrich, 22, 146-5) |
| Aluminium hydroxide | 29.36 | (Reheis, 4135) |
| (79.7% Al(OH)₃) | | |
| Colloidal silicon dioxide | 60.0 | (Aldrich, 42, 082-4) |
| (30% in water) | | |
| Distilled water | 492.0 | |

Two solutions, one of sodium aluminate (A) and one of sodium silicate (B) were prepared by mixing the above reactants in the following ratios (in grams):

(A) 29.36 Al(OH)₃+182 H₂O+72 NaOH

(B) 60 SiO₂+310 H₂O+108 NaOH

The two solutions were stirred in closed vessels until all the components were completely dissolved, which was indicated by the clarity of the solutions. The solutions were cooled to room temperature and mixed with vigorous stirring (V=800 revs./min.). The mixture was homogenised for 60 minutes. The molar composition of the reaction mixture was:

7.5Na₂O: 0.50Al₂O₃: 1.0SiO₂: 100H₂O

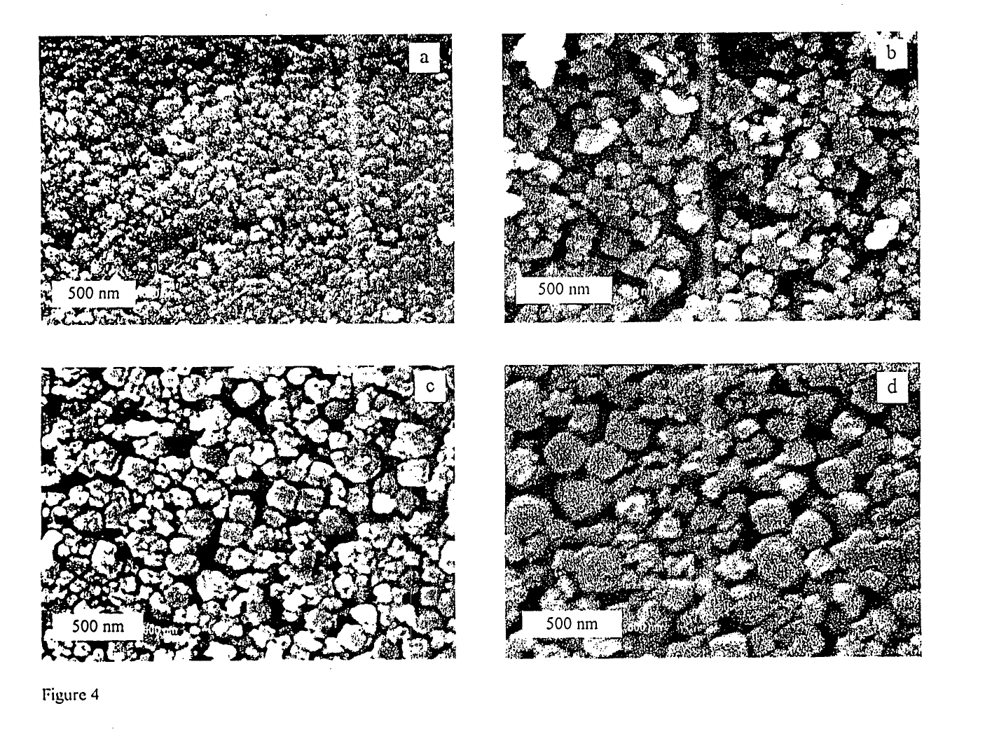

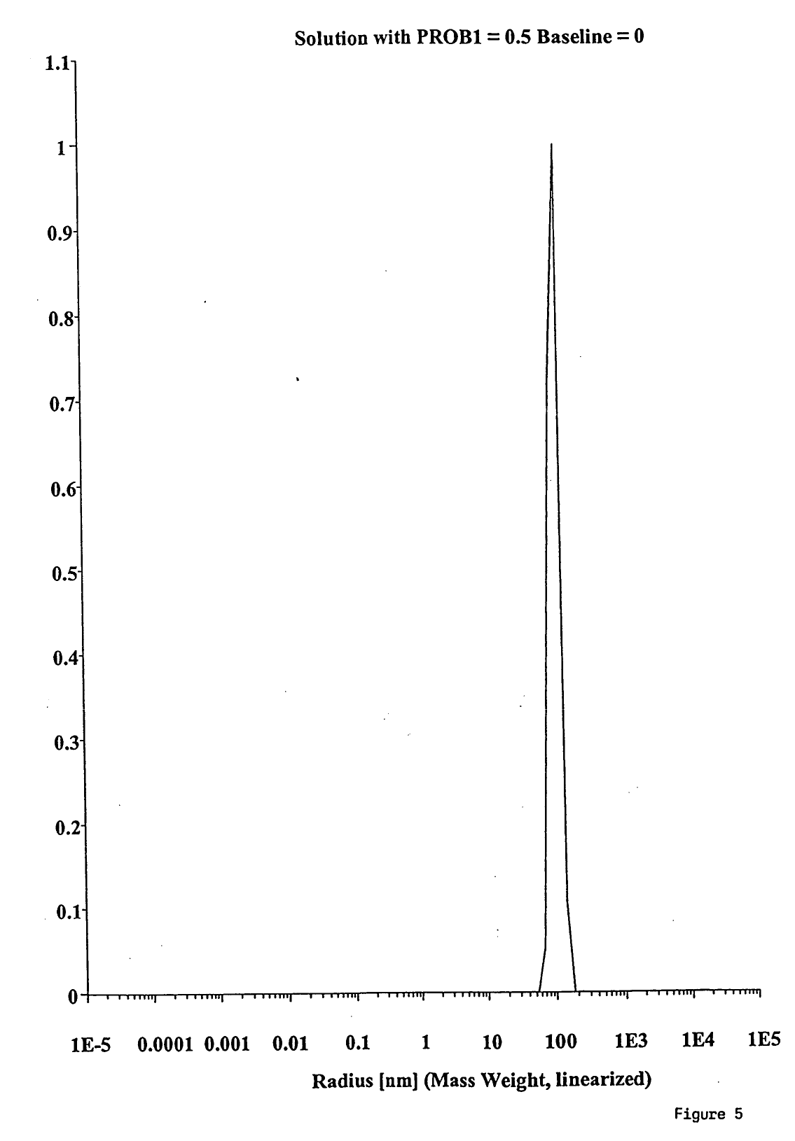

The synthesis mixture was divided into four equal portions, which were crystallised at 60° C. for 2 hours, at 40° C. for 8 hours, at 33° C. for 24 hours and at 18-22° C. for 7 days. The syntheses were carried out in plastics bottles. The products were purified and stabilised as described hereinbefore. Small aliquots of the zeolite suspensions were evaporated to dryness and analysed by means of an X-ray diffraction diagram. All the diffractograms showed the typical diffraction pattern of zeolite A. The SEM samples were prepared by evaporating a few microlitres of the highly diluted LTA suspensions on an SEM sample holder. The difference in the size of the LTA crystals obtained at different temperatures can be seen in FIG. 4. The DLS (dynamic light scattering) data for the sample produced at 33° C. are shown in FIG. 5. The external surface area of the sample produced at 33° was 130 m²/g.

### Example 3

This Example illustrates the preparation of nanoscale FAU crystals having a mean particle size of about 300 nm.

A synthesis solution having a molar composition of:

5Na₂O: 0.2Al₂O₃: 1.0SiO₂: 200H₂O

was prepared by mixing the reactants indicated below. The mass of each reactant is given in grams and the product number of each reactant is indicated in brackets after the name of the manufacturer/supplier.

| | | |
|---|---|---|
| Sodium hydroxide pellets (97%) | 40 | (Aldrich, 22, 146-5) |
| Aluminium hydroxide | 3.91 | (Reheis, 4135) |
| (79.7% Al(OH)₃) | | |
| Colloidal silicon dioxide | 20 | (Aldrich, 42, 082-4) |
| (30% in water) | | |
| Distilled water | 346 | |

The mass of each reactant in grams for the two solutions is indicated below:

(A) 3.91 Al(OH)₃+20 H₂O+10 NaOH

(B) 20 SiO₂ (30%)+120 H₂O+30 NaOH

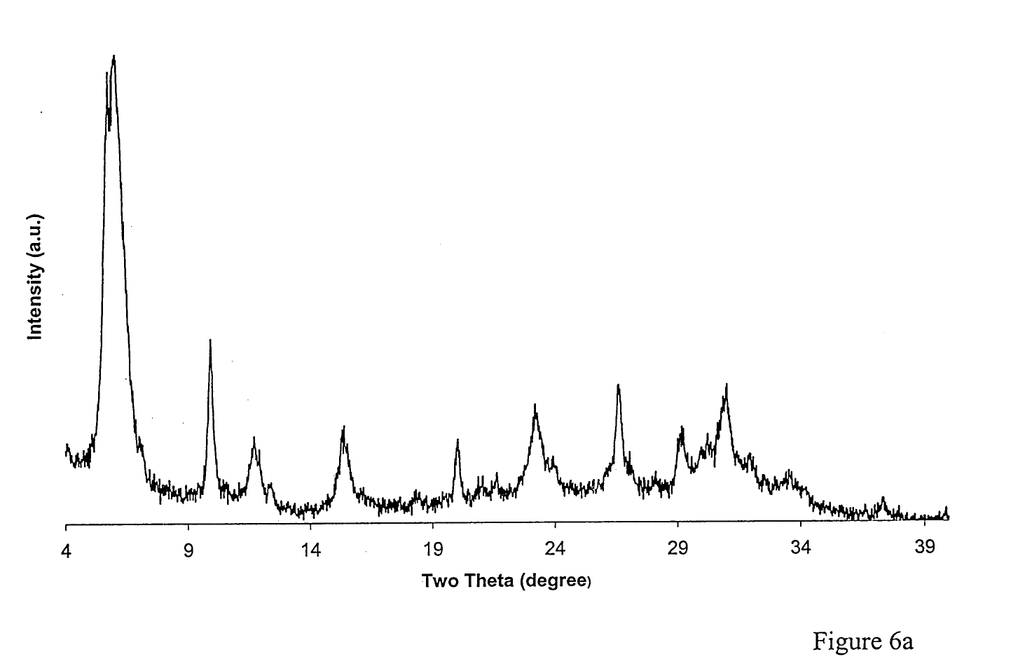

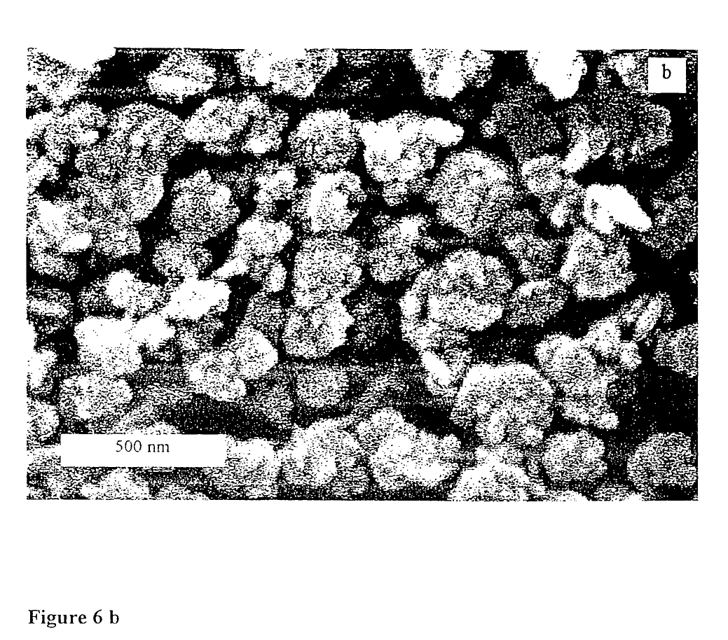

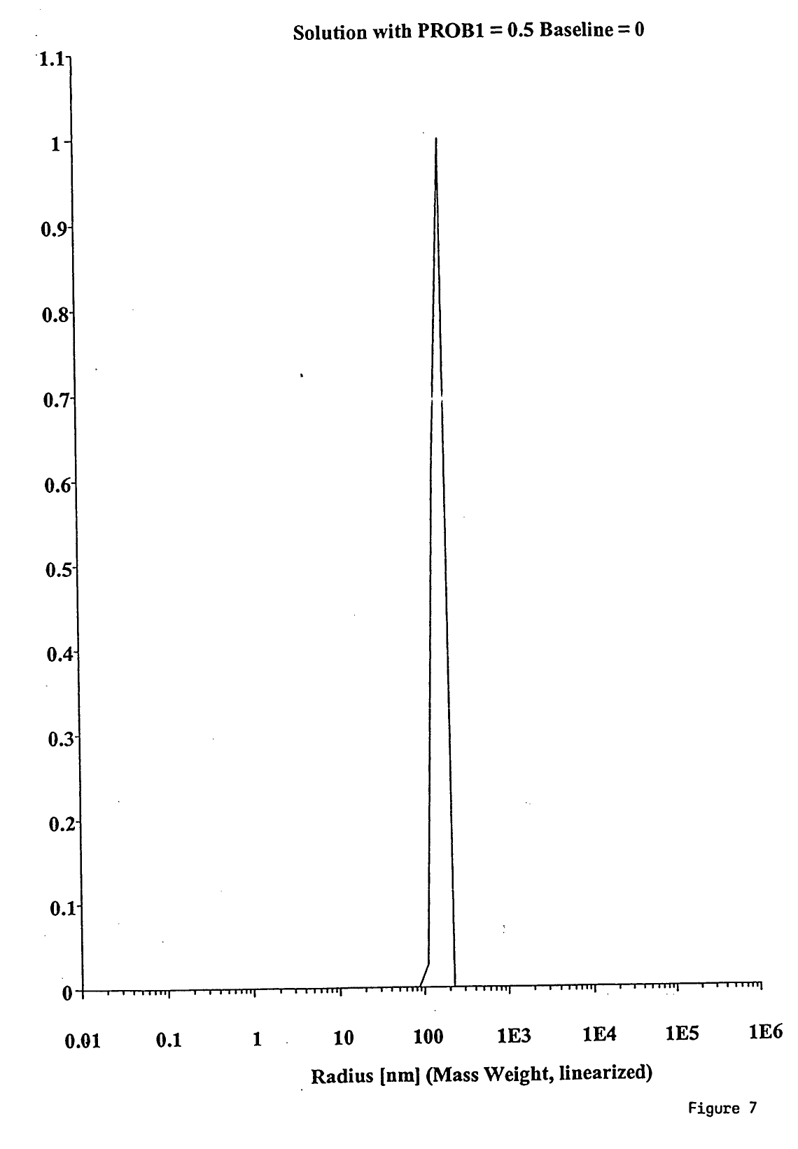

The starting mixtures were stirred in closed vessels until clear solutions were obtained. Solutions (A) and (B) were diluted with 80 and 126 grams of distilled water, respectively. The clear solutions were mixed, with vigorous stirring (V=600 revs./min.), and homogenised for 50 minutes. Before synthesis, the gel was transferred to a polypropylene bottle and aged for 24 hours at room temperature. Crystallisation was carried out in the same plastics bottle for 17 hours at 80° C. The solid was separated off from the mother liquor and purified as described hereinbefore. The X-ray diffraction pattern of the sample and an electron micrograph are shown in FIGS. 6a and b. The particle sizes and the particle size distribution are shown in FIG. 7.

### Example 4

This Example illustrates the preparation of nanoscale FAU crystals having a mean particle size of about 230 nm.

A synthesis solution having a molar composition of:

3.8Na₂O: 0.2Al₂O₃: 1.0SiO₂: 150H₂O

was prepared by mixing the reactants indicated below. The mass of each reactant is given in grams and the product number of each reactant is indicated in brackets, after the name of the manufacturer/supplier.

| | | |
|---|---|---|
| Sodium hydroxide pellets (97%) | 30.4 | (Aldrich, 22, 146-5) |
| Aluminium hydroxide | 3.91 | (Reheis, 4135) |
| (79.7% Al(OH)₃) | | |
| Colloidal silicon dioxide | 20.0 | (Aldrich, 42, 082-4) |
| (30% in water) | | |
| Distilled water | 256.0 | |

The mass of each reactant in grams for the starting solutions was as follows:

(A) 3.91 Al(OH)₃+20 H₂O+9 NaOH

(B) 20.0 SiO₂ (30%)+80 H₂O+21.4 NaOH

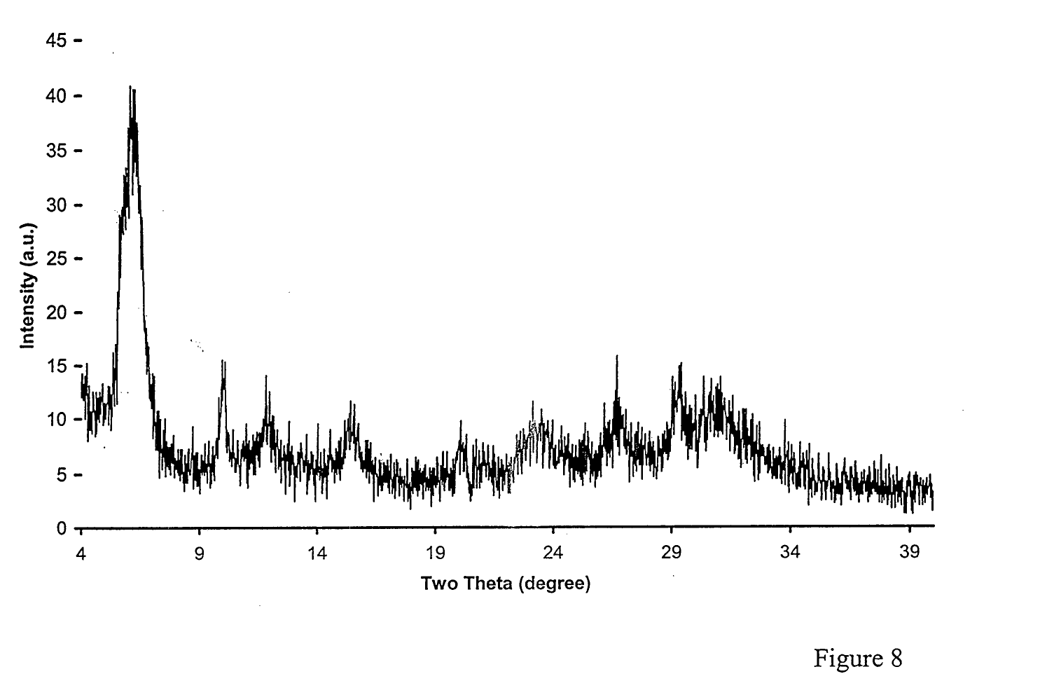

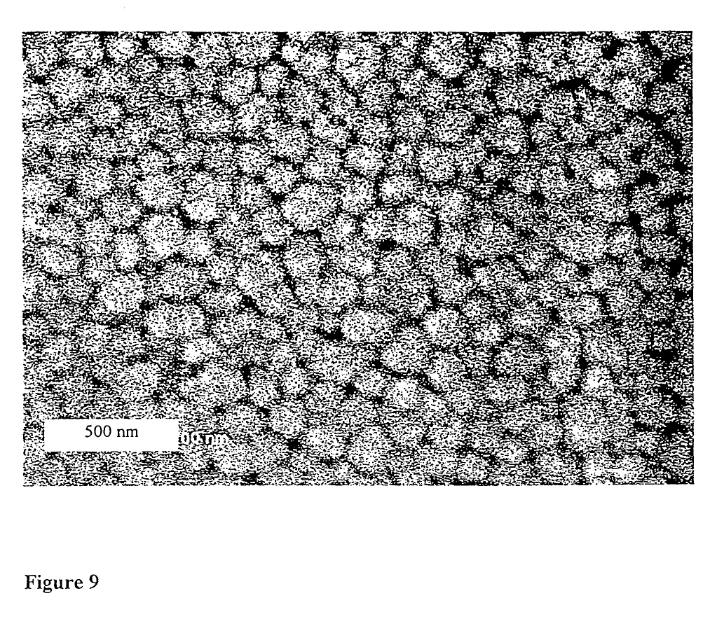

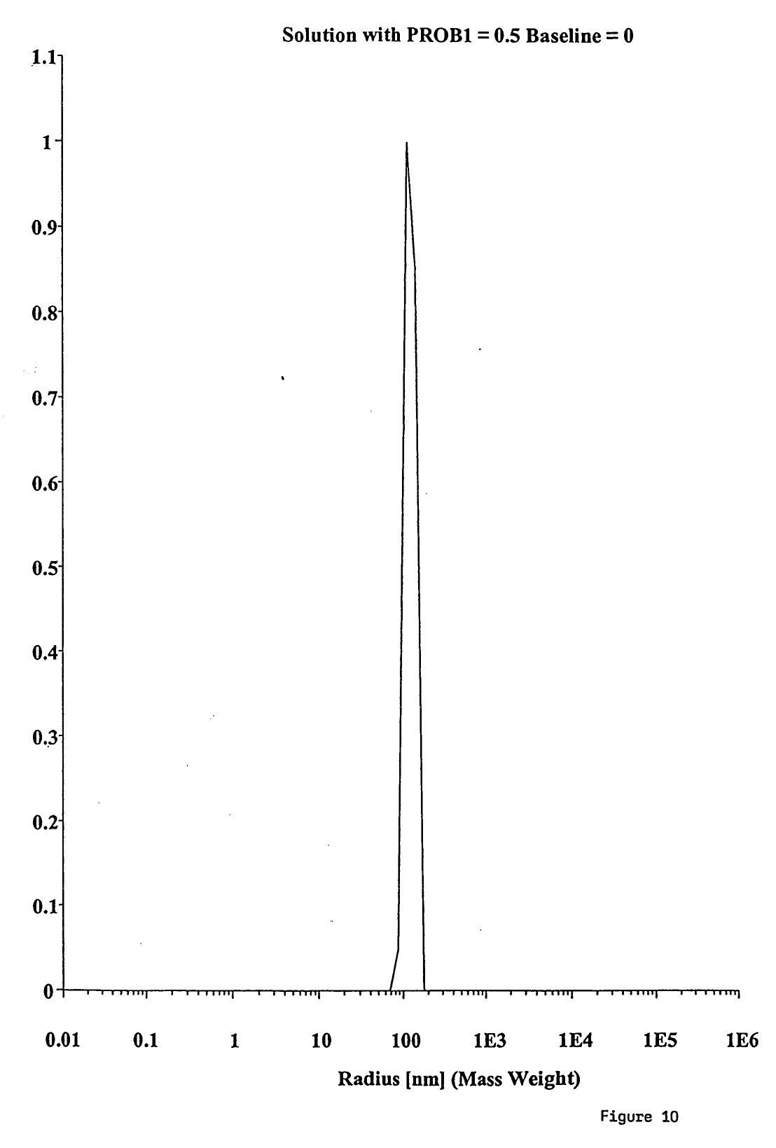

The starting mixtures were stirred in closed vessels until clear solutions were obtained. Solutions (A) and (B) were diluted with 60 and 96 grams of distilled water, respectively. The clear solutions were mixed, with vigorous stirring (V=600 revs./min.), and homogenised for 70 minutes. The gel was aged for 20 hours at room temperature and then heated for 24 hours at 60° C. The X-ray diffraction pattern of the purified solid is typical for FAU-type materials. The X-ray diffraction pattern, electron micrograph and DLS particle size distribution for the sample are shown in FIGS. 8, 9 and 10, respectively.

### Example 5

This Example illustrates the preparation of nanoscale EDI-type crystals having a mean particle size of about 400 nm.

The reactants used in this experiment are indicated below. The mass of each reactant is given in grams and the product number of each reactant is indicated in brackets, after the name of the manufacturer/supplier.

| | | |
|---|---|---|
| Sodium hydroxide pellets (97%) | 60.0 | (Aldrich, 22, 146-5) |
| Potassium hydroxide pellets (85%) | 126.0 | (Aldrich, 30, 656-8) |
| Aluminium hydroxide | 24.47 | (Reheis, 4135) |
| (79.7% Al(OH)₃) | | |
| Colloidal silicon dioxide | 50.0 | (Aldrich, 42, 082-4) |
| (30% in water) | | |
| Distilled water | 396.0 | |

The starting solutions were prepared by mixing the following reactants (in grams):

(A) 24.47 Al(OH)₃+150 H₂O+30 NaOH+50 KOH

(B) 50 SiO₂ (30%)+246 H₂O+30 NaOH+76 KOH

The two solutions were stirred in closed vessels until all the components were completely dissolved, which was indicated by the clarity of the solutions. The solutions were cooled to room temperature and mixed with vigorous stirring (V=800 revs./min.). The mixture was homogenised for 120 minutes. The molar composition of the synthesis mixture was:

3.8K₂O: 3.0Na₂O: 0.50Al₂O₃: 1.0SiO₂: 100H₂O

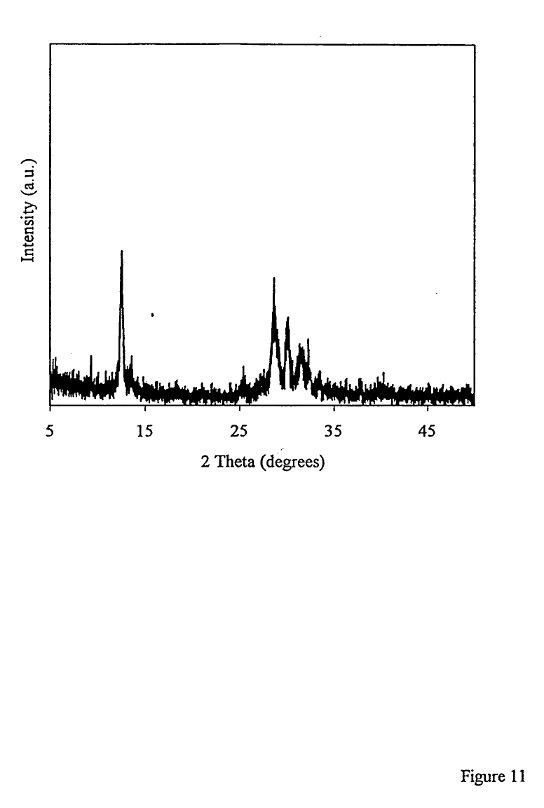

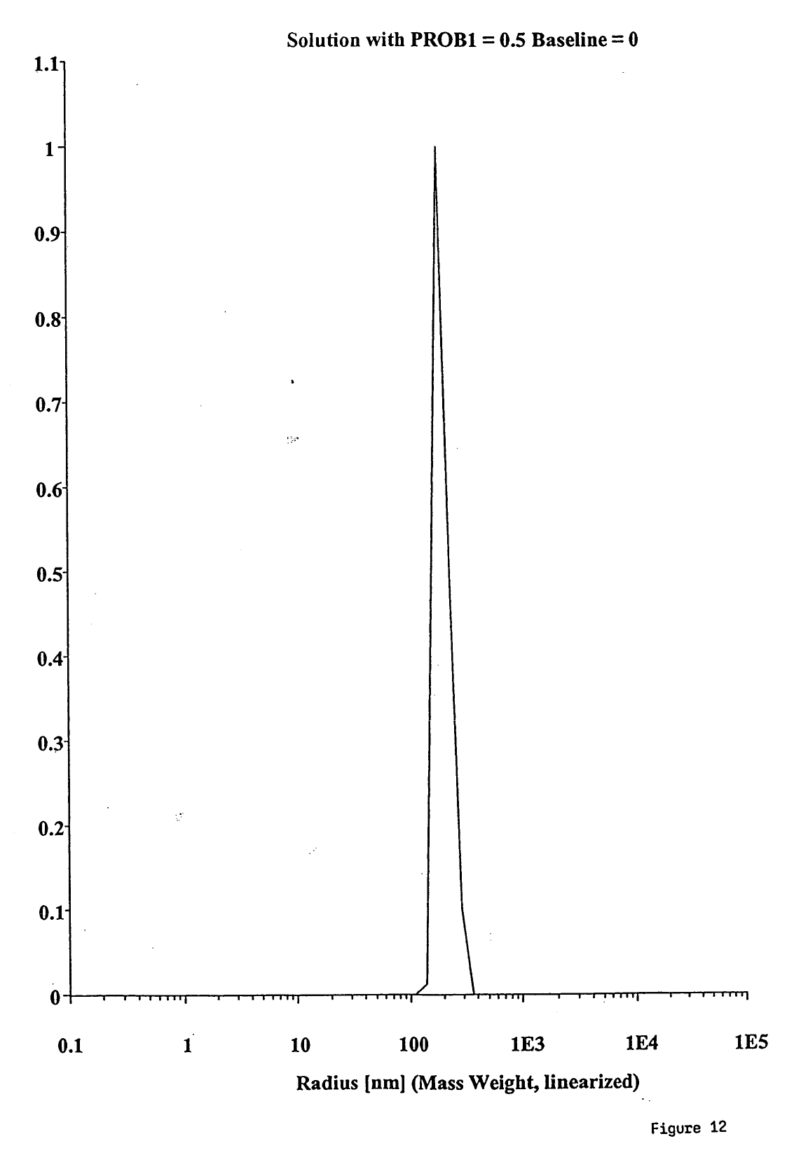

The resulting milky-white suspension was transferred to a plastics bottle and heated for 30 hours at 60° C. The solid was separated off from the mother liquor and treated as described hereinbefore. The dry product was identified as an EDI-type zeolite (K-F) by X-ray diffraction patterns (FIG. 11). The particle size distribution is shown in FIG. 12.

### Example 6

In order to improve the colloidal stability of the zeolite suspension still further, a hydrothermal treatment was carried out after synthesis. The purified zeolite A suspension (2.2% zeolite by weight) prepared in Example 1 was treated with 0.5M NH₃ solution. 50.0 g of the zeolite suspension were mixed with 50.0 g of NH₃ solution and heated for 20 hours at 60° C. After the hydrothermal treatment, the solid was removed from the liquid by centrifugation (V=15,000 revs./min., 30 min.), redispersed in distilled water using an ultrasonic bath and then centrifuged under the same conditions. The washing was repeated until the pH value of the washing water was less than 9. After the final washing step, the LTA crystals were again redispersed in distilled water and the pH value was adjusted to a value between 9 and 10 by adding 0.1M NH₃ solution. Even after standing for several weeks at room temperature, the nanoscale zeolite particles showed no tendency to separate out. An aliquot of the suspension was evaporated to dryness. The X-ray diffraction pattern of the solid is typical for LTA-type materials. The intensity of the peak was similar to that of the starting materials.

### Example 7

A further improvement in the colloidal stability of the nanoscale zeolite crystals can be achieved by using surface-active agents. An aliquot of the suspension that had been subjected to a hydrothermal treatment after synthesis (Example 6) was used in this experiment. 10.0 g of suspension, which contained 0.75% zeolite A by weight, were mixed with 1.0 g of a 0.025M solution of Brij 76 (C₁₈H₃₇(OCH₂CH₂)₁₀OH), which was supplied by Aldrich. After briefly mixing, the solution was transferred to a plastics bottle. After it had stood for one month at room temperature, the suspension showed no tendency to separate out.

1. Method for the preparation of zeolite particles having an average particle size of less than 1000 nm, wherein
a) a solution of a silicate and/or germanate source and a base is prepared,
b) a solution of an aluminate and/or gallate source and a base is prepared, and
c) the solutions a) and b) are brought together and reacted, characterised in that
the silicate and/or germanate source in step a) and the aluminate and/or gallate source in step b) are readily soluble in the bases; and
the pH value of the solution in step a) is at least 11; and
the pH value of the solution in step b) is at least 11.

2. Method according to claim 1, characterised in that
no alkylammonium ions or other organic structure-directing agents are used.

3. Method according to any one of the previous claims, characterised in that
in step a) the molar ratio of base to silicate and/or germanate source is at least 2:1; and
in step b) the molar ratio of base to aluminate and/or gallate source is at least 2:1.

4. Method according to any one of the previous claims, characterised in that the silicate and/or germanate particles in the solutions in step a) have a mean particle size of max. 10 nm; and
the aluminate and/or gallate particles in the solutions in step b) have a mean particle size of max. 10 nm.

5. Method according to any one of the previous claims, characterised in that
the solution in step a) is a clear solution; and
the solution in step b) is a clear solution.

6. Method according to any one of the previous claims, characterised in that the bases are alkali and/or alkaline earth bases.

7. Method according to any one of the previous claims, characterised in that d) the mixture c) is purified.

8. Method according to any one of the previous claims, characterised in that the mixture c) or the purified mixture d) is stabilised.

9. Method according to claim 8, characterised in that the stabilisation is carried out by adding at least one stabilising agent, such as a surface-active coupling agent and/or a surface-active agent or polymers, to the mixture c) or to the purified mixture d).

10. Method according to claim 9, characterised in that the agents are silane coupling agents such as aminopropyltrimethoxysilane, glycidyloxypropyltrimethoxysilane, trimethylmethoxy-silane or organic esters of phosphonic or phosphoric acid such as dimethyl methyl phosphonate or dibutyl phosphate.

11. Method according to any one of claims 8 to 10, characterised in that an additional or alternative stabilisation is carried out by adding at least one dispersant to the purified mixture d).

12. Method according to claim 11, characterised in that the dispersant is a non-ionic, cationic or anionic surface-active agent in monomeric, oligomeric or polymeric form.

13. Method according to any one of the previous claims, characterised in that the zeolite particles have an average particle size of less than 500 nm.

14. Method according to any one of the previous claims, characterised in that the zeolite particles have a particle size distribution of max. ±30%.

15. Method according to any one of the previous claims, characterised in that the zeolite particles or aggregates thereof have external surface areas of more than 50 m²/g.

16. Method according to any one of the previous claims, characterised in that the silicate source is selected from alkali and/or alkaline earth silicates, silica sols, Aerosils and organic silica complexes such as silicon alkoxides.

17. Method according to claim 16, characterised in that the silica sol has an average particle size of max. 100 nm.

18. Method according to any one of the previous claims, characterised in that the aluminate source is selected from alkali aluminates, aluminium alkoxides and amorphous aluminium hydroxides.

19. Method according to any one of the previous claims, characterised in that the bases are added in such amounts that the silicate and/or germanate source and the aluminate and/or gallate source are completely dissolved.

20. Method according to any one of the previous claims, characterised in that vigorous mixing is carried out in steps a), b) and c).

21. Method according to any one of the previous claims, characterised in that step c) is carried out at a temperature in the range from 10 to 60° C.

22. Method according to any one of the previous claims, characterised in that, in steps a) and/or b), sources of gallium, germanium, phosphorus, boron, titanium, iron, chromium, beryllium, vanadium or other metal ions are additionally added.

23. Method according to claim 22, characterised in that the sources are oxides of the metals.

24. Method according to any one of the previous claims, characterised in that steps a) and b) are carried out at a pH value of at least 12.

25. Method according to any one of the previous claims, characterised in that steps a) and b) are carried out at a pH value of at least 13 or at least 14.

26. Nanoscale zeolite particles obtainable by a method according to any one of the previous claims.

27. Colloidal suspensions which comprise nanoscale zeolite particles according to claim 26 in a suspending agent.

28. Use of the nanoscale zeolite particles and/or colloidal suspensions thereof according to either claim 26 or 27 as ion-exchangers, molecular sieves, catalyst supports, detergents or seed crystals in zeolite synthesis.

29. Use of the nanoscale zeolite particles and/or colloidal suspensions thereof according to either claim 26 or 27 in porous membranes.

30. Use of the nanoscale zeolite particles and/or colloidal suspensions thereof according to either claim 26 or 27 as pigments or pigment supports.

31. Use of the nanoscale zeolite particles and/or colloidal suspensions thereof according to either claim 26 or 27 as precursors for ceramic materials.
